(19) United States
(12) Patent Application Publication
(10) Pub. No.: US 2011/0148090 A1
(43) Pub. Date: Jun. 23, 2011

(54) Low profile Tank Trailer

(76) Inventors: Joey DelaRosa, Henderson, TX (US); Timothy Scott Thomas, Henderson, TX (US)

(21) Appl. No.: 12/646,675

(22) Filed: Dec. 23, 2009

(51) Int. Cl. B60P 3/22

(52) U.S. Cl. 280/837

(57) ABSTRACT

A tank trailer to transport flowable material may include a frame. a tank to hold the flowable material connected to the frame, and the tank may include a first section, a second section connected to the first section and a third section connected to the second section. The first section may include a first diameter and the third section may include a second diameter. The second section may include a decreasing diameter to connect the first section and to connect the third section. The decreasing diameter may include a inclined surface, and the second portion may include an inclined side surface. The second portion may include an inclined bottom surface, and the tank trailer may include a convex front wall. The tank trailer may include a convex back wall, and the tank trailer may include a rib. The tank trailer may include a king pin.

### FIELD OF THE INVENTION

The present invention relates to a tank trailer for transporting dry and liquid flowable materials.

### BACKGROUND

Many forms of tank trailers have been devised for transporting flowable materials including liquids and a wide variety of pulverulent and granular solid materials. One such tank trailer has a horizontally disposed substantially cylindrical tank with upwardly inclined ends and a plurality of hoppers formed in the bottom of the tank to facilitate the unloading of the tank. The tank is provided on its top with a number of filler openings for loading of the tank. The tank may also be divided into a number of compartments so that each compartment can be loaded and unloaded separately and independently of the other compartments. The inclined or sloping end structure of the tanks facilitates the downward flow of dry and liquid flowable materials when these materials are being unloaded through the hopper bottoms. A suitable frame structure is then attached to each end of the tank at the lower portion thereof so that one frame structure serves as a supporting carriage for wheels and the other frame structure is provided with a trailer hitch for connecting the trailer to a tractor.

U.S. Pat. No. 4, 346, 905 discloses a tank trailer for transporting dry and liquid flowable materials which may include a horizontally disposed substantially cylindrical tank having front and rear transverse end walls. On each end wall is a hopper structure inclining upwardly and outwardly from the bottom portion of each end wall and having a width considerably less than the diameter of the tank. Extending horizontally from the bottom portions of the respective end walls are front and rear platforms. These platforms each have a width approximately equal to the diameter of the tank and are adapted to carry freight thereon in the manner of a flatbed trailer.

### SUMMARY

A tank trailer to transport flowable material may include a frame. a tank to hold the flowable material connected to the frame, and the tank may include a first section, a second section connected to the first section and a third section connected to the second section. The first section may include a first diameter and the third section may include a second diameter. The second section may include a decreasing diameter to connect the first section and to connect the third section.

The decreasing diameter may include a inclined surface, and the second portion may include an inclined side surface.

The second portion may include an inclined bottom surface, and the tank trailer may include a convex front wall.

The tank trailer may include a convex back wall, and the tank trailer may include a rib.

The tank trailer may include a king pin.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the tank trailer of the present invention;

FIG. 2 illustrates a perspective view of the tank trailer of the present invention;

FIG. 3 illustrates a back view of the tank trailer of the present invention;

FIG. 4 illustrates a front view of the tank trailer of the present invention.

FIG. 5 illustrates a portion of the tank trailer of the present invention;

FIG. 6 illustrates a top view of the tank trailer of the present invention.

### DETAILED DESCRIPTION

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

The tank trailer 100 includes a lower profile than conventional tank trailers and as a result provides increased performance and reduced center of gravity, allowing for fewer rollovers.

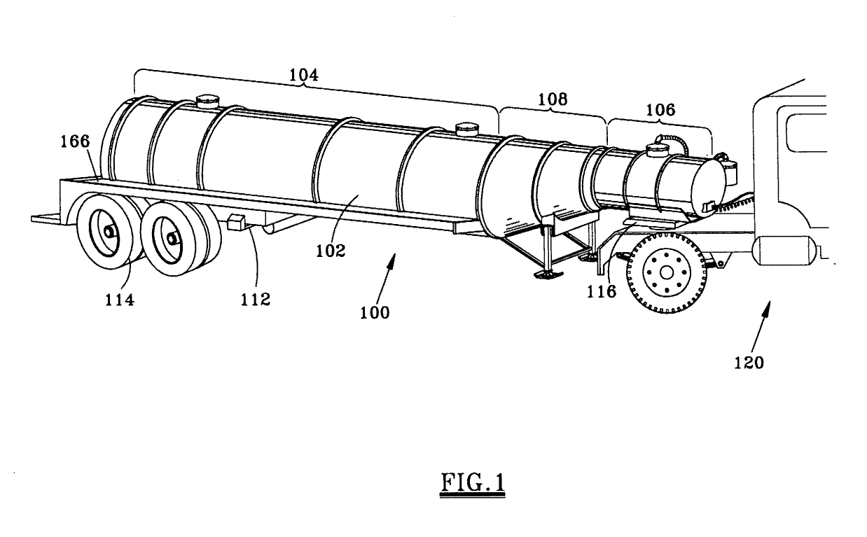

FIG. 1 illustrates a tank trailer 100 which may be used to transport flowable material such as liquid such as fuel including gasoline, diesel fuel or other types of fuel or a dried flowable material such as seed and which may include a tank 113 which may include first section 101, a second section 103 and a third section 105. The tank 113 may be substantially cylindrical, substantially oval, substantially rectangular or any other shape and may include a first section 101, a second section 103, and a third section 105. The tank 113 may include more or fewer sections than the three sections 101, 103, 105. The first section 101 may include a substantially cylindrical shape which may include a substantially smaller diameter and a substantially constant diameter with respect to the second section 103 and the third section 105, and the third section 105 may include a substantially larger diameter and a substantially constant diameter with respect to the first section 101 and the second section 103. The tank 113 additionally includes the second section 103 which may include a first portion 107, a second portion 109 and a third portion 111. The first portion 101 may be the substantially same diameter of the first section 101 and may connect to the first section 101. The second portion 109 may include a decreasing diameter/inclined surface (sloping) which may be the bottom surface of the second portion 109, and the second portion may include a side surface 133 which may include a decreasing diameter/inclined surface (sloping). The top surface 135 of the second portion 109 may be substantially in the same plane as the top surface of the first portion 107 and the top surface of the third portion 109. Alternatively, the top surface 135 of the second portion 109 may include a decreasing diameter/inclined surface (sloping).

The third portion 111 may be substantially a cylinder in order to connect to the third section 105. The first portion 107 may be substantially a cylinder in order to connect to the first section 101.

The first section 101, the second section 103 and the third section 107 may include man hole covers 137 which may cover manholes 139 to access the hollow interior of the tank 101.

The exterior surface of the tank 101 may include ribs 141 which may radially extend around the exterior surface of the tank 101 to provide structural support to the tank 101.

The tank 101 may include a convex front wall 143 and a convex back wall 145; alternatively, the front wall 143 and the back wall 145 could be substantially planar or could be concave. The tank 101 may also include a first valve 143 and an opposing second valve 145 to drain and fill the tank 101.

The tank 113 may be hollow and may include a single or double hull construction.

The third section 105 may have a substantial constant diameter which may be larger than the diameter of the first section 101.

The tank trailer 100 may include a king pin plate 143 which may be connected to the tank 113 and a king pin 145 which may be connected to the king pin plate 143 in order to facilitate connection to a tractor vehicle.

The tank trailer 100 may include a frame 147 to support the tank 113, and the frame 114 may be connected to a forward support device 145 which may be extendable and retractable in order to support the tank trailer 100 while the tank trailer 100 is not connected to a tractor (not shown).

Additionally, a wheel carriage/support unit 149 may be connected to the frame 147 to maintain a spaced relationship between the surface and the tank 113 and may include wheels to transport the tank trailer 100.

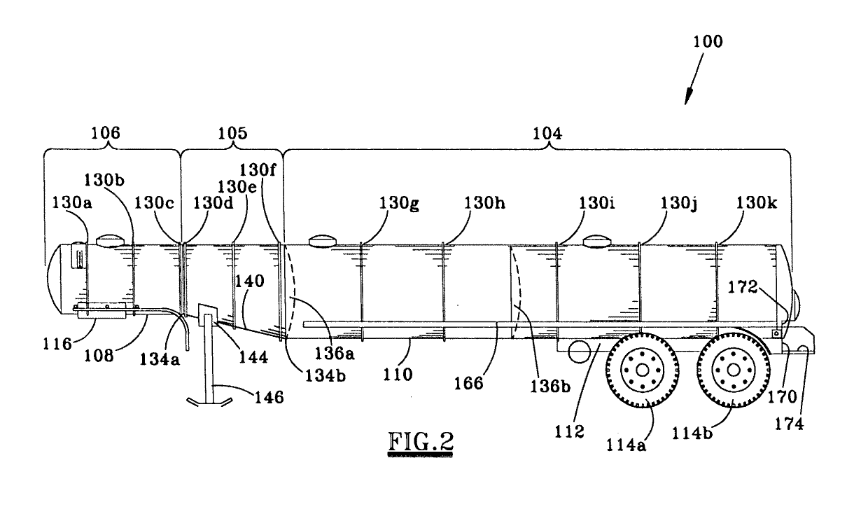

FIG. 2 illustrates a perspective view of the tank trailer 100, and FIG. 2 illustrates a tank trailer 100 which may be used to transport liquid such as fuel including gasoline, diesel fuel or other types of fuel or a dried flowable material such as seed and which may include a tank 113 which may include first section 101, a second section 103 and a third section 105. The tank 113 may be substantially cylindrical, substantially oval, substantially rectangular or any other shape and may include a first section 101, a second section 103, and a third section 105. The tank 113 may include more or fewer sections than the three sections 101, 103, 105. The first section 101 may include a substantially cylindrical shape which may include a substantially smaller diameter and a substantially constant diameter with respect to the second section 103 and the third section 105, and the third section 105 may include a substantially larger diameter and a substantially constant diameter with respect to the first section 101 and the second section 103. The tank 113 additionally includes the second section 103 which may include a first portion 107, a second portion 109 and a third portion 111. The first portion 101 may be the substantially same diameter of the first section 101 and may connect to the first section 101. The second portion 109 may include a decreasing diameter/inclined surface (sloping) which may be the bottom surface of the second portion 109, and the second portion may include a side surface 133 which may include a decreasing diameter/inclined surface (sloping). The top surface 135 of the second portion 109 may be substantially in the same plane as the top surface of the first portion 107 and the top surface of the third portion 109. Alternatively, the top surface 135 of the second portion 109 may include a decreasing diameter/inclined surface (sloping).

The third portion 111 may be substantially a cylinder in order to connect to the third section 105. The first portion 107 may be substantially a cylinder in order to connect to the first section 101.

The first section 101, the second section 103 and the third section 107 may include man hole covers 137 which may cover manholes 139 to access the hollow interior of the tank 101.

The exterior surface of the tank 101 may include ribs 141 which may radially extend around the exterior surface of the tank 101.

The tank 101 may include a convex front wall 143 and a convex back wall 145; alternatively, the front wall and the back wall could be substantially planar or could be concave. The tank 101 may also include a first valve 143 and a opposing second valve 145 to drain and fill the tank 101.

The tank 113 may be hollow and may include a single or double hull construction.

The third section 105 may have a substantial constant diameter which may be larger than the diameter of the first section 101.

The tank trailer 100 may include a king pin plate 143 which may be connected to the tank 113 and a king pin 145 which may be connected to the king pin plate 143.

The tank trailer 100 may include a frame 147 to support the tank 113, and the frame 114 may be connected to a forward support device 145 which may be extendable and retractable in order to support the tank trailer 100 while the tank trailer 100 is not connected to a tractor (not shown).

Additionally, a wheel carriage/support unit 149 may be connected to the frame 147 to maintain a spaced relationship between the surface and the tank 113 and may include wheels to transport the tank trailer 100.

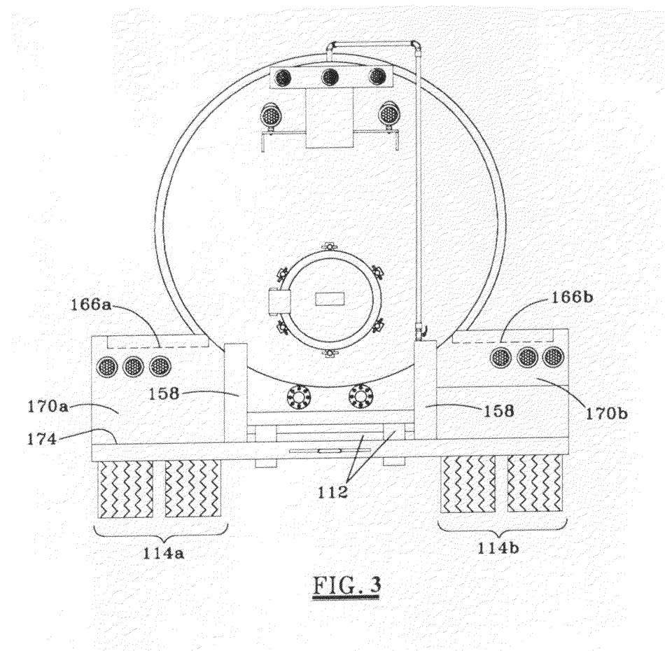

FIG. 3 illustrates the back of the tank trailer 100 and illustrates the first valve 143, the second valve 135, the frame 147 the wheel carriage 149, the back wall 145, the man hole cover 137.

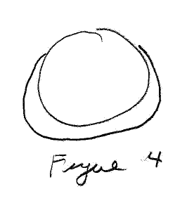

FIG. 4 illustrates the front wall 143 of the first section 103.

FIG. 5 illustrates a top view of the tank trailer 100 and illustrates the frame 147, the ribs 141, the front wall 143, the back wall 145, the man hole covers 137, and the first and second valves 143, 145 and the tank 113.

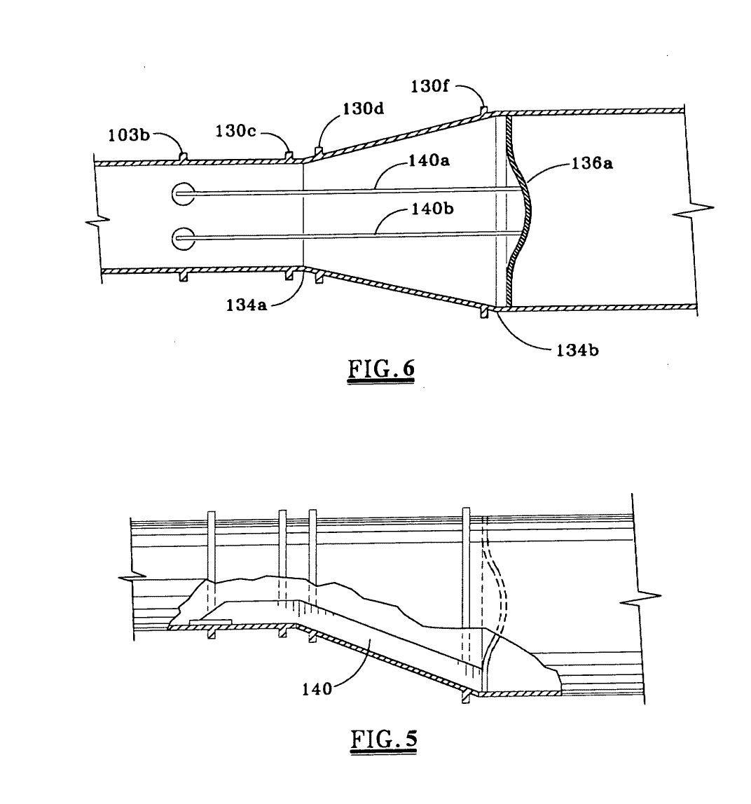

FIG. 6 illustrates a portion of the tank trailer 100 including the first section 101, a second section 10 3 and a third section 105. The tank 113 may be substantially cylindrical, substantially oval, substantially rectangular or any other shape and may include a first section 101, a second section 103, and a third section 105. The tank 113 may include more or fewer sections than the three sections 101, 103, 105. The first section 101 may include a substantially cylindrical shape which may include a substantially smaller diameter and a substantially constant diameter with respect to the second section 103 and the third section 105, and the third section 105 may include a substantially larger diameter and a substantially constant diameter with respect to the first section 101 and the second section 103. The tank 113 additionally includes the second section 103 which may include a first portion 107, a second portion 109 and a third portion 111. The first portion 101 may be the substantially same diameter of the first section 101 and may connect to the first section 101. The second portion 109 may include a decreasing diameter/inclined surface (sloping) which may be the bottom surface of the second portion 109, and the second portion may include a side surface 133 which may include a decreasing diameter/inclined surface (sloping). The top surface 135 of the second portion 109 may be substantially in the same plane as the top surface of the first portion 107 and the top surface of the third portion 109. Alternatively, the top surface 135 of the second portion 109 may include a decreasing diameter/inclined surface (sloping).

The third portion 111 may be substantially a cylinder in order to connect to the third section 105. The first portion 107 may be substantially a cylinder in order to connect to the first section 101.

1. A tank trailer to transport flowable material, comprising:
a frame;
a tank to hold the flowable material connected to the frame;
the tank including a first section, a second section connected to the first section and a third section connected to the second section;
wherein the first section includes a first diameter and the third section includes a second diameter; and
where in the second section includes a decreasing diameter to connect the first section and to connect the third section.

2. A tank trailer to transport flowable material as in claim 1, wherein the decreasing diameter includes a inclined surface.

3. A tank trailer to transport flowable material as in claim 1, wherein the second portion includes a inclined side surface.

4. A tank trailer to transport flowable material as in claim 1, wherein the second portion includes a inclined bottom surface.

5. A tank trailer to transport flowable material as in claim 1, wherein the tank trailer includes a convex front wall.

6. A tank trailer to transport flowable material as in claim 1, wherein the tank trailer includes a convex back wall.

7. A tank trailer to transport flowable material as in claim 1, wherein the tank includes a rib.

8. A tank trailer to transport flowable material as in claim 1, wherein the tank trailer includes a king pin.
